(19) United States
(12) Patent Application Publication
(10) Pub. No.: US 2025/0209424 A1
(43) Pub. Date: Jun. 26, 2025

(54) SYSTEMS AND METHODS FOR THE AUTOMATION OF WORKFORCE ACQUISITION, ALLOCATION, DISTRIBUTION, ENGAGEMENT, AND ENABLEMENT

(71) Applicant: Brahma Vella, Bellevue, WA (US)

(72) Inventor: Brahma Vella, Bellevue, WA (US)

(21) Appl. No.: 18/394,309

(22) Filed: Dec. 22, 2023

(51) Int. Cl. G06Q 10/1053; G06F 21/31; G06Q 10/0631

(52) U.S. Cl. CPC G06Q 10/1053; G06F 21/31; G06Q 10/063112

(57) ABSTRACT

This invention provides systems, and methods for the automated assistance of worker location, acquisition, training, and utilization.

### FIELD OF THE INVENTION

This invention generally relates to systems and methods for the automation of workforce acquisition, allocation, distribution, engagement, and enablement, and more specifically, to a system that assists with the full spectrum of handling a workforce, whether employee or contractor, from the acquisition of new employees and contractors to onboarding, to pay and finally to termination of the relationship.

### BACKGROUND OF THE INVENTION

A significant cost point for many businesses is the acquisition and payment of employees and contractors, with many spending hundreds of thousands of dollars searching for candidates, interviewing them, determining whether their skillset fits the company's needs, hiring them, training them, compensating them, and so on. The present invention resolves many of these challenges by creating a comprehensive system that streamlines the process with an innovative approach to locating workers and facilitating the entire process of location, hiring, and ultimately parting ways with the worker. Presently, many of the issues related to securing a workforce are related to disconnects and mismatching of various needs, such as the distribution of workers, the level of engagement of the worker, and the skillsets of each worker. Traditionally, these had to be determined in the abstract by a company by reviewing a job application and interviewing a worker; a process that is fraught with potential for disconnect between company and worker, and where economic and other conditions can exacerbate the likelihood of misunderstanding.

### BRIEF SUMMARY

The present invention is a series of modules that interconnect in order to provide a novel, seamless means to connect workers, whether as employees, contractors, or other forms of agents, to those in need of their services, and to provide related assistance such as onboarding and training to such workers, in an efficient manner. In order to improve such efficiency, the present invention does away with many traditional approaches to forming the worker-client relationship instead focusing on the skillsets of workers and the needs of the client in order to match the parties and move the relationship forward.

For ease of understanding, the platform that comprises the present invention may be broken into three discrete modules: the workforce module, the work module, and the workspace module. At the same time, the invention provides monitoring capabilities applicable to the relationship so that clients can track their work ecosystems, but also provides feedback and information to workers to assist them along their path. Put simply for ease of understanding, without limiting the invention, the workforce module facilitates the creation of the worker-client relationship, allowing parties to find workforce to perform tasks; the work module assists in the completion of tasks; and the workspace module administers the related matters. In some embodiments, these modules and their sub-modules may be consolidated or further divided; some embodiments may possess additional modules to provide new features or may split an existing module into multiple modules depending on the need of the embodiment.

In some further embodiments, the modules and their sub-modules, as applicable, may be implemented on a computer system and possibly through a network, wherein the system may comprise singular computer system, a cloud, a series of servers, a hybrid of the foregoing, or in alternative arrangements. For example, some embodiments may be configured to run the work module on a cloud server, while the workspace and work modules runs on an instance on a client's server. In some embodiments, one or more of the modules may be web based such that the users access them through the internet, while in others they, or some of the modules, may be downloaded or installed software applications. Depending on the needs of the embodiment, some of the modules or the system may be configured to run on a plurality of device types, such as standard computers or mobile devices. In some embodiments, some of all of the modules may be accessible via one or more digital interfaces, and access to said interface may be based on whether the user is a worker, client, or partner.

In the case of the workforce module, the module comprises a variety of sub-systems that interface in order to facilitate the overall module system. The workforce module, depending on the embodiment of the invention, may perform a variety of functions and have a variety of interactions with workers, clients, and partners. For example, the workforce module may allow workers and or partners to upload information and data about information such as, but not limited to, a worker's qualifications, certifications, skillset, experience, and other relevant information such as, but not limited to, location, pay rates, availability, and similar employment data. The module may then permit a client and/or partner to review this information. Some embodiments of the workforce module of the system may incorporate an automated system wherein a client has provided, to the system directly or to a partner, a series of requirements for a task, and the system is configured to review the relevant information from workers currently available to determine if one or more of said workers meet the requirements, and in some embodiments may be able to determine a degree to which potential workers meet said requirements. For example, it may be such that the client's requirements are extensive, or for some reason no specific worker meets all of the requirements; in such situations, the system may be configured with instructions to gauge each worker's fit to the requirements based on a variety of weights provided by the client and/or partner, or programmed into the system. In such an example, the system may identify a Worker A that meets 95% of the client's requirements, while a Worker B may meet 91% of the client's requirements, and in such case, the system may present both as options and in some embodiments may highlight particular differences of the workers presented such that the client can determine that a worker with lower compatibility with the requirements may still be a preferable choice. In some embodiments, the client may be capable of adjusting the associated weights of its requirements to see how different workers compare. Some embodiments of the invention may permit the client to select, or may only permit, the system itself to automatically select the candidate with the highest alignment with the client's requirements and automatically initiate the hiring process.

Some examples of the invention may permit the client to make decisions disregarding the proposed alignment with the client's needs and hire workers that the client deems are preferable to the task. Similarly, some embodiments of the invention may permit the client, partner, or system to set certain dependent weights on various aspects of the worker, such as, by way of example, favoring proximity to a client, thus elevating a worker's apparent alignment with the needs of the client higher when the worker's physical location is closer. In other embodiments, the client or partner may be further capable of more granular determines of applicability of a given credential or even credential organization. For example, a particular client may require the given worker have a college degree, but may then rank specific educational institutions more highly, so while two workers may have college degrees, one with a preferred educational institution may be ranked higher by the system. In some examples, the weights desired of a client may be programmed algorithmically into the system or may be facilitated by an artificial intelligence system or similar system.

Depending on the embodiment in question, the workforce module may be further configured, as described above, to facilitate the hiring process. Once a worker has been identified by the system, a client, or a partner for a particular work requirement of the client, the system facilitates the hiring process by extending an offer to the worker on behalf of the client, or in some cases directly from the client. The worker then may be provided the option to accept the offer from the client, or in some cases may have configured the system to automatically accept the offer. Once the worker has accepted the offer, the system transitions to the work module which is where the worker is capable of performing tasks under the supervision of the client and/or partner. In some embodiments of the system, it may be configured to make offers to workers automatically if they meet a certain threshold based on their credentials, with the system reaching out with an offer on behalf of the client. In other embodiments, it may provide a list of workers that meet the credential requirements to partners who can then review workers and make offers on behalf of the client.

In some embodiments, the workforce module may be configured to further assess a potential worker's skillset based on criteria of the client such as a particular worker's role in previous engagements. For example, the system may look at the worker's particular role in projects as compared to their skillset (presently or at the time of the previous projects) to determine their fit, and in some examples it may reveal that a particular worker may have ample experience in a field, but that experience may be in a non-management role, thus causing the system to weigh the worker's skillset differently in such a role. The assessments described herein may be handled by a software algorithm with or without human assistance, while in other implementations the assessments and other features may be facilitated by an artificial intelligence, large language model, or similar system.

Other criteria the system may consider include, but not limited to: (1) the level of engagement of the worker with the company, such as whether they were a freelancer, a temporary worker, or a permanent worker; (2) the types of services the worker provide, whether they offered definition, design, development, test/quality, or deployment work; or (3) the distribution of the worker, whether they have worked in an office setting, report setting, or hybrid thereof. In addition to the foregoing, other qualities of a worker and their skillset may be considered, with such being potentially combined into a 16-digit hex code to describe the candidate and/or the position being applied for. In the event the system is configured with an algorithm, such algorithm may take those or other factors into account, along with weights determined by the client.

For example, in some embodiments of the invention, the system may assign numerical values and/or weights to different aspects of a candidate's profile, such as, but not limited to, education, work experience, skills, and cultural fit. The company or partner can then configure the weights based on their specific needs or preferences. One company may choose to highly weight education, and potentially weigh higher certain institutions, while another may select a more even weight distribution. By way of further example, a company in a certain industry might configure the system to give greater weight to technical skills and relevant work experience and might be quantified as a 40% weight for technical skills, 30% weight for work experience, 20% for education, and the remaining 10% for cultural fit. While the foregoing four factors are exemplary, they are not exhaustive and the system is configured to work with other categories or forms of information as well, such as the location of the worker or compensation expectations, to name a few possibilities.

Based on the foregoing weights, the system, in some embodiments, would calculate a total score for each candidate. To use the foregoing example, the candidate with strong technical skills but less work experience might score highly due to technical skills being weighted more strongly. However, for a different user, the candidate with greater work experience may be ranked more highly if the weight of work experience is increased.

In some embodiments, the system may be further configured to assist the client seeking a worker with the interview process. An embodiment may feature a manual mode, where the client handles the interview themselves, while another embodiment may feature an autonomous mode where the worker is presented specific questions by a bot or similar construct and answers them, or in other embodiments, there may be a hybrid system in which the bot or similar construct guides a user interviewer on questions to ask or consider asking.

The work module is configured to function as space where a worker can perform one or more tasks for a client based on the needs of the client, and the client will have shared access to that space, though depending on the needs of the embodiment and the configuration thereof the two may have different levels of interactivity with the space. For example, in some embodiments, some or all of the representatives of the client may have full access, while in others, they may have supervisory or “read-only” access to the work module being used by the worker.

For some embodiments of the invention, the work module may be configured to assign tasks, potentially referred to as “workitems” to workers that have accepted a position with the client. These workitems are distributed to the worker(s) via the Work module.

The work module of the invention, in some examples, may organize the client's organization into workteams, wherein each workteam is working on predefined (or evolving) workflows. Each workteam performs various workitems which may be further broken down into individual tasks. When the client requires a task to be completed, a workteam is chosen, assigned the workitems, which are then resolved.

Some variants of the work module may permit workitems to have a variety of states, such as, but not limited to: (1) open workitems that are not yet assigned or completed; (2) working workitems that are in process by a workteam; (3) blocked workitems that cannot presently be worked on because of another workitem; (4) resolved workitems that are being reviewed by the client; and (5) closed workitems that are considered complete.

The work module may further provide an actual work area for the worker to work, accessed digitally via a digital interface that the client, worker, and potentially partners all have access to, wherein the worker can perform workitems and other tasks for the client, and the client can view them. In some embodiments, the work module may integrate with other software or similar programs to facilitate the performance of tasks, such as, for example, integrating with code visualization programs and displaying them within the work module.

The workspace module allows the client to handle administrative tasks related to the work and can be accessed by all users including, without limitation, workers, partners, and clients. For example, some embodiments of the workspace module may permit the use of features such as, but not limited to: (1) a workboard wherein worker details associated with a particular client or partner can be stored; (2) assets wherein information is stored regarding workstations, hardware, software, networks, etc.; (3) a leave system which permits management of worker leave; (4) a payroll module wherein payroll can be managed; (5) a document module wherein worker and client documents can be stored and managed; (6) a contracts module that is configured to store agreements between client and worker, as well as other agreements by the parties; (7) a policies module whereby the client and/or partners can store policies such as employee handbooks, bring-your-own-device policies, cybersecurity policies, etc.; (8) a calendar module that allows the users to store dates and share such calendars, and in some embodiments this module can sync with the work module to track projects and deadlines; and (9) a refresher module designed to contain training and orientation materials for the system itself as well as those of clients and/or partners. Depending on the implementation of the system, some of the foregoing modules may be further automated; for example, the payroll module may be automated to automatically remit payment to workers.

Each of the foregoing modules may have its own sub-modules and they may be configured to interact. For example, the calendar module and the refresher module may coordinate to have the calendar module regularly recommend to workers that they review certain training and orientation materials. Similarly, the calendar module may be linked to the leave module, allowing the worker to calendar their leave, and it may be further configured to connect with the policies module, wherein that module regulates how workers may request leave, or provide additional information about leave.

In some embodiments, the invention is a system for the management of workforces, the system comprising: at least one computer processor communicably connected to at least one computer memory, wherein the computer memory stores a plurality of information including at least; information regarding at least one partner, at least one candidate, and at least one employer; wherein the computer processor is programmed to: to match the at least one candidate with the at least one employer, notify the at least one employer if it has matched an at least one candidate and is configured to allow the employer to select the candidate, assess the candidate, and offer to select the candidate, provide a means for the at least one partner to interface with the at least one candidate and propose them to the at least one employer, permit the at least one candidate to confirm the employer's selection, perform a verification of at least one credential of a candidate; provide an at least partially electronic workspace for the at least one candidate wherein the at least one employer is able to view the partially electronic workspace; allows the at least one employer to create one or more tasks in the workspace and permits the candidate to interact with the one or more tasks; provide the at least one employer an electronic repository whereby the at least one employer can store information related to the one or more tasks and the at least one candidate; wherein the computer processor is connected to a network.

Further embodiments of the system may feature a computer memory that is further configured to store information regarding a skillset of at least one candidate and information regarding a set of needs for at least one employer; and the computer processor is further configured to analyze a skillset of the at least one candidate and a set of needs of the at least one employer to determine a degree of overlap between them, or wherein the computer processor will only match the at least one candidate to the at least one employer if the degree of overlap of the skillset of the at least one candidate and the needs of the at least one employer exceed a preset threshold.

Additional embodiments may have the computer processor configured to enable the partner to perform at least one of the following functions: consult with the at least one employer; assess the at least one candidate; or provide at least one of mentorship, coaching, or training to the at least one candidate, or is further configured to enable the partner to review potential matches between the at least one candidate and at least one employer to determine if the computer processor's analysis requires supplementation and to supplement or override the analysis to force or cancel a match between the at least one candidate and at least one employer.

Depending on the arrangement of components, the at least one candidate and at least one employer connect to the system through a computerized interface wherein at least some elements of the interface are visible to both parties, and/or the at least one employer is able to review and receive a result of the at least one candidate's performance of the at least one tasks.

Additional embodiments of the invention may have the computer processor configured to further consider one or more criteria set by the at least one employer and determine whether the one or more criteria is applicable to the at least one candidate prior to matching; configured to enable the at least one employer to adjust the one or more criteria and needs at any time, and is further configured to enable the at least one employer to adjust a matchmaking weight of the one or more criteria and its needs and have the matchmaking weight impact the computer process's determination of whether to match the at least one employer with the at least one candidate; configured to permit the at least one employer to adjust the matchmaking weight of the one or more criteria and its needs relative to each other and make the weights of some of the one or more criteria and its needs dependent on the at least one candidate's possession of others; configured to automatically assign the at least one task to the at least one candidate after the at least one candidate is selected and approves of the selection where the assignment is based on the skillset of that at least one candidate; and/or configured to make the assignment to the at least one candidate based on the skillset of the at least one candidate in relation to the need of the at least one employer.

Similarly, in some examples of the invention the invention features a computerized interface that is connected to a network and the at least one candidate, if selected by the at least one employer and if the at least one candidate accepted the selection, is capable of performing at least one task related to the needs of the employer using the computerized interface.

Represented as a method, the invention may be embodied as a method for the management of employer and candidate relationships, the method comprising: maintaining a platform accessible by at least one candidate and at least one employer; receiving information related to an at least one need of the at least one employer and information related to an at least one skillset of the at least one candidate; determining whether the at least one skillset of the at least one candidate matches the at least one need of the at least one employer to a sufficient degree wherein the sufficient degree is determined by the at least one employer; notifying the at least one employer if the at least one skillset of the at least one candidate matches the at least one need of the at least one employer to the sufficient degree set by the at least one employer; permitting the at least one employer to select the at least one candidate and the at least one candidate to accept the selection by the at least one employer: providing a computerized workspace where the at least one candidate can perform one or more tasks for the at least one employer where the computerized workspace is at least partially shared between the at least one candidate and at least one employer.

Some embodiments of the method may comprise further steps, including, but not limited to; providing a mechanism for the at least one employer to evaluate the at least one candidate's performance on the one or more tasks; connecting, over a network, the at least one candidate and an at least one partner who provides assistance to the at least one candidate where such assistance is chosen from the list of: mentorship, training, or coaching; weighing one or more characteristics of the at least one candidate in addition to the at least one skillset of the at least one candidate based on weights provided by the at least one employer; facilitating determining the weight of the one or more characteristics and the at least one skillset of the at least one candidate based on the needs of the at least one employer; and/or automatically assigning at least one task related to the at least one need of the at least one employer to the at least one candidate.

### BRIEF DESCRIPTION OF THE DRAWINGS

Embodiments of the present invention are described in detail below with reference to the following drawings:

FIG. 1 depicts a system diagram showing the overall arrangement of the system and the means by which the modules and users interact, in accordance with an embodiment of the invention;

FIG. 2 depicts a flow diagram demonstrating the process that users undergo when interacting with the workforce module of the system, in accordance with an embodiment of the invention;

FIG. 3 depicts a system diagram of a workforce module of the worker management system in accordance with an embodiment of the invention;

FIG. 4 depicts a system diagram of a worker credential assessment module of the worker management system in accordance with an embodiment of the invention;

FIG. 5 depicts a system diagram of a work module of the worker management system in accordance with an embodiment of the invention; and

FIG. 6 depicts a chart demonstrating the flow of work in the work module of the worker management system in accordance with an embodiment of the invention.

### DETAILED DESCRIPTION

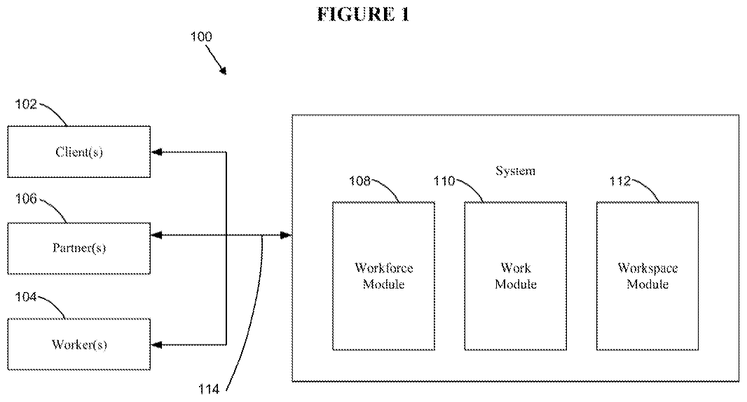

FIG. 1 depicts a system diagram showing the overall arrangement of the workforce management system 100 and the means by which the modules and users interact. In some embodiments, the system is comprised of one or more clients 102 that are users, with the clients 102 representing individuals and other entities (such as, but not limited to, companies and limited liability entities) in need of workers 104 to perform tasks; one or more partners 106 who are individuals capable of providing a variety of services to the clients 102 and workers 104 such as, but not limited to, facilitating interviews, training workers 104, assessing potential worker 104 recruits, or uploading worker 104 or client 102 information; then there are one or more workers 104 who are individuals or entities interested in performing tasks in exchange for compensation. These parties interact with the overall system, which is comprised of three primary modules, the workforce module 108 which handles the recruitment process, the work module 110 that handles the task performance process, and the workspace module 112 which handles the administrative side of the relationship. The clients, 102 partners 106, and workers 104, are able to interact with the system 100 over a network 114 but may also interact with certain features offline and upload the results when they are networked again.

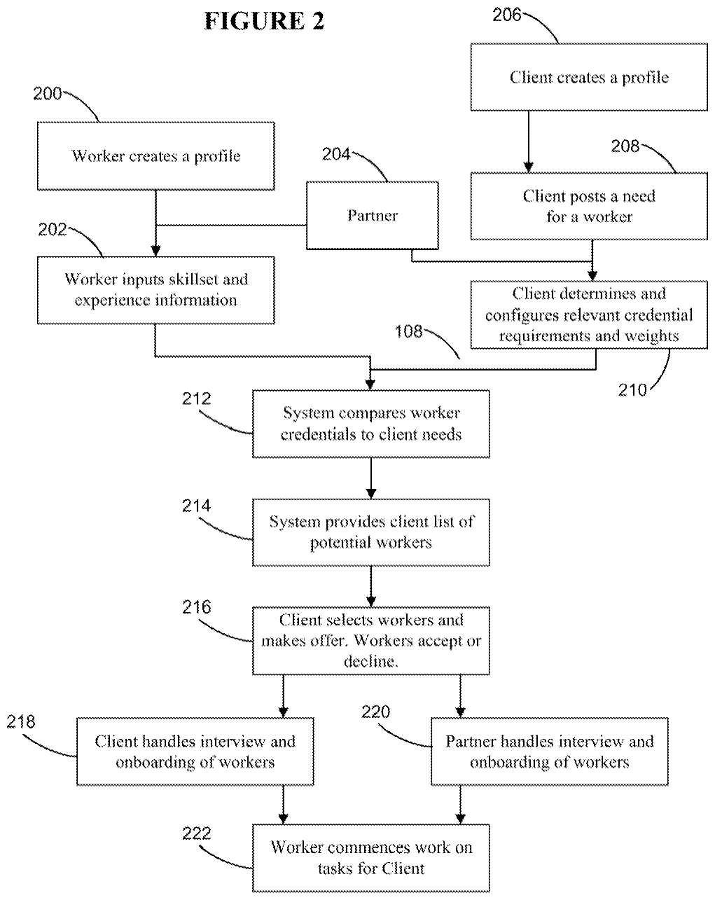

FIG. 2 depicts a flow diagram demonstrating the process that users undergo when interacting with the workforce module of the system, in accordance with an embodiment of the invention. In some embodiments, the workforce module functions according to the following steps: first one or more workers first create a profile within the system 200, followed by inputting information about themselves such as their skillsets, education, and/or experience information 202. Various embodiments of the invention may call for different information from workers. In some embodiments, the worker can import information from a third-party source, or in some cases third parties may have the capability of uploading information about workers independently. For example, an educational institution may be permitted to upload information about recent graduates. In some embodiments, a partner 204 may be involved in the step of creating the worker profile and inputting the skillset.

At the same time, after the worker has input their information, or beforehand, a client may create a profile 206 and post a need for a worker for a particular job or position 208. The client may then, optionally, determine and configure relevant credential requirements and/or weights of specific credentials at that time 210. In some embodiments, the client may be able to have a partner 204 perform the role of posting the job or position or handling the credentials step.

Once both the client and worker have configured their relative sides of the arrangement, which may have been facilitated by a partner, the system takes the information provided by the worker(s) and compares it to the weights and requirements provided by the client 212. The system will then rank the workers and present that information to the client and/or its partners for review 214. From there, the client can select workers and make offers thereto, which may be accepted or declined 216. Once an applicable worker has accepted, the client and/or a partner may facilitate the interview and onboarding process until workers have been fully accepted 218 and 220 respectively. Once the worker is onboarded, they may commence work tasks for the client through the work module 222.

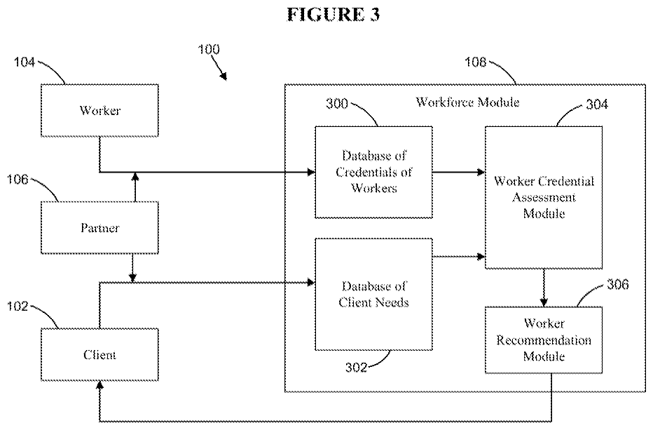

FIG. 3 depicts a system diagram of a workforce module 108 of the worker management system 100 in accordance with an embodiment of the invention. As can be seen, the workforce module 108 is broken into a number of sub-components that perform various functions based on input from the worker 104, partner 106, and client 102. As depicted, the worker 104 and/or partner 106 inputs information regarding the worker 104 into the workforce module 108 into a database 300 that stores data of credentials and other information about workers 104. The client 102 and/or partners 106 then inputs data into the workforce module 108 database 302 regarding the client's 102 needs, which may be comprised of information including but not limited to the needs of the client 102, the weights the client 102 assigns to various credentials of the worker 104, and other information relevant to the position to be filled by the worker 104. The data regarding the client's 102 needs and the data regarding worker 104 credentials and information are then fed through a worker credential assessment module 304, which performs the relevant calculation to rank workers 104, and then feeds that to the worker recommendation module 306, which allows the client 102 and/or partner 106 to review workers 104.

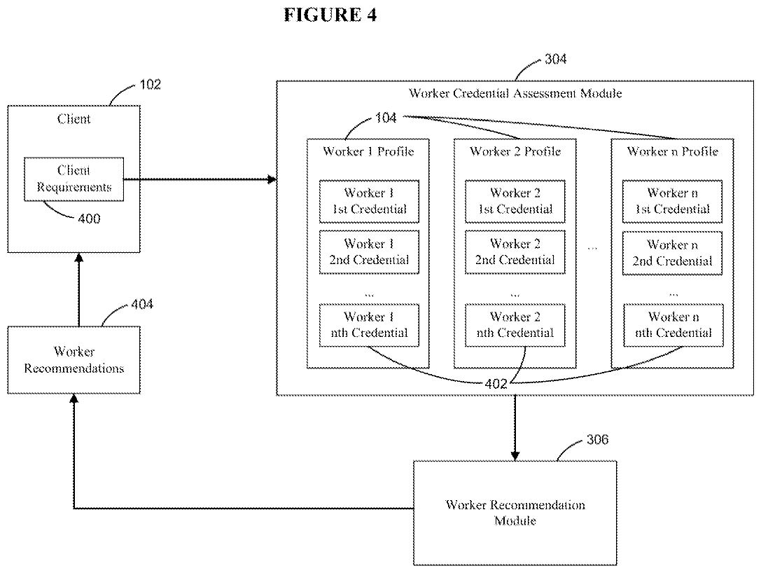

FIG. 4 depicts a system diagram of a worker credential assessment module 304 of the worker management system 100 in accordance with an embodiment of the invention. In some embodiments of the invention, the worker credential assessment module 304 receives client requirements 400 from the client 102, which may include, but are not limited to, the credentials the client 102 is looking for, weights for those credentials, and other information relevant to the needs of the client 102. This information is fed into the worker credential assessment module 304, which is already filled with profiles of various workers 104, anywhere from one to a plurality (represented by n) of workers 104 who have one to a plurality of various credentials 402 uploaded into the system 100. The worker credential assessment module 304 assesses these credentials 400 relative to the client requirements 400, and then feeds the results to the worker recommendation module 306, which can then provide recommendations 404 for workers 104 to the client 102.

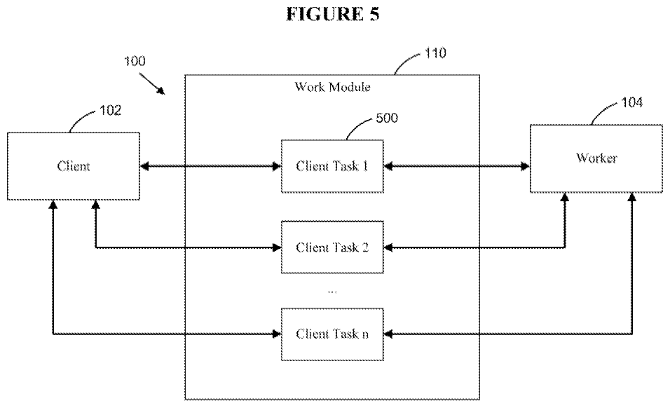

FIG. 5 depicts a system diagram of a work module 110 of the worker management system 100 in accordance with an embodiment of the invention. As demonstrated, for some embodiments the work module 110 is comprised of one or more tasks 500 created by the client 102 and provided to the worker(s) 104. In some embodiments, the worker(s) 104 can choose which client tasks 500 to perform, while in others, all depending on the needs of the client 102, the client 102 may assign specific tasks 500 to the worker 104 to perform. The worker 104 is then able to use the work module 110 to perform the tasks 500 requested and provide the results of the finished tasks 500 to the client 102. In many embodiments, both parties will have the ability to review tasks simultaneously.

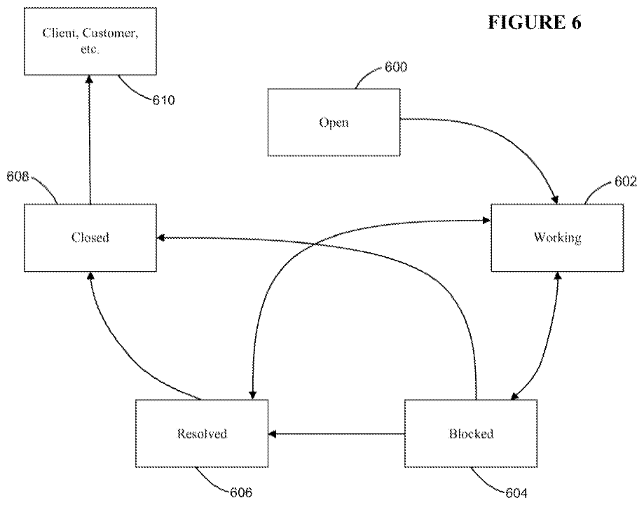

FIG. 6 depicts a chart demonstrating the flow of work in a work module of the worker management system in accordance with an embodiment of the invention. As depicted in FIG. 6, first, the client creates a number of tasks that need to be performed by workers. These tasks can be labeled as open 600, working 602, blocked 604, resolved 606, or closed 608. In some embodiments, additional statuses may be used depending on the needs of the client and the nature of the tasks, among other factors. A task marked as open 600 is a task that is not yet complete or being worked on by a specific worker or team of workers. Once a task is chosen and/or assigned to a worker, the task moves to working 602, which represents that one or more workers are actively working on such task. A task may then move to become blocked 604 if there is an issue preventing it from being completed, such as, but not limited to, required approval by a superior, a missing component, awaiting another task's completion, a bug or flaw is in need of remediation, or other potential issues. Once the issue causing the block status is removed the task may then move back to working 602, or it may move to resolved 606, or in some circumstances the block may necessitate that the task become closed and replaced with alternative tasks. Tasks may also move directly from working 602 to resolved 606. In the resolved 606 stage, tasks are reviewed by authorized personnel or systems for completeness or errors, and if there are errors, they may be sent back to working 602 or blocked 604. Once the resolved 606 stage is complete and a task is considered complete, it may move to closed 608, where it is considered completed. Once the task, or in some embodiments a group of related tasks, are completed and the end result is finalized, it is sent back to the client and/or an end customer 610.

While a number of exemplary aspects and embodiments have been discussed above, those of skill in the art will recognize certain modifications, permutations, additions, and sub-combinations thereof. It is therefore intended that the following appended claims and claims hereafter introduced are interpreted to include all such modifications, permutations, additions, and sub-combinations as are within their true spirit and scope.

The foregoing examples should be viewed as demonstrations of potential embodiments and are not exhaustive or necessarily conclusive as to the effectiveness of the present invention. In many situations, it may be preferable to utilize mixtures and conditions different from the above or use an embodiment of the invention which an example may have indicated was less effective but may be more optimal in such situation.

As used herein and unless otherwise indicated, the terms “a” and “an” are taken to mean “one”, “at least one” or “one or more”. Unless otherwise required by context, singular terms used herein shall include pluralities and plural terms shall include the singular.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application. Many changes, modifications, variations and other uses and applications of the present construction will, however, become apparent to those skilled in the art after considering the specification and the accompanying figures. All such changes, modifications, variations and other uses and applications which do not depart from the spirit and scope of the invention are deemed to be covered by the invention which is limited only by the claims which follow.

It should be understood that while certain preferred forms, embodiments, and examples of this invention have been illustrated and described, the present invention is not to be limited to the specific forms or arrangement of parts described and shown, and that the various features described may be combined in other ways than those specifically described without departing from the scope of the present invention. The invention is intended to cover alternatives, modifications and equivalents, which may be included within the spirit and scope of the invention as defined by the appended claims.

What is claimed is:

1. A system for the management of workforces, the system comprising:
at least one computer processor communicably connected to at least one computer memory, wherein the computer memory stores a plurality of information including at least;
information regarding at least one partner, at least one candidate, and at least one employer;
wherein the computer processor is programmed to;
to match the at least one candidate with the at least one employer, notify the at least one employer if it has matched an at least one candidate and is configured to allow the employer to select the candidate, assess the candidate, and offer to select the candidate, provide a means for the at least one partner to interface with the at least one candidate and propose them to the at least one employer, permit the at least one candidate to confirm the employer's selection, perform a verification of at least one credential of a candidate;
provide an at least partially electronic workspace for the at least one candidate wherein the at least one employer is able to view the partially electronic workspace; allows the at least one employer to create one or more tasks in the workspace and permits the candidate to interact with the one or more tasks; provide the at least one employer an electronic repository whereby the at least one employer can store information related to the one or more tasks and the at least one candidate;
wherein the computer processor is connected to a network.

2. The system of claim 1, wherein the computer memory is further configured to store information regarding a skillset of at least one candidate and information regarding a set of needs for at least one employer; and the computer processor is further configured to analyze a skillset of the at least one candidate and a set of needs of the at least one employer to determine a degree of overlap between them.

3. The system of claim 2, wherein the computer processor will only match the at least one candidate to the at least one employer if the degree of overlap of the skillset of the at least one candidate and the needs of the at least one employer exceeds a preset threshold.

4. The system of claim 1, wherein the computer processor is further configured to enable the partner to perform at least one of the following functions: consult with the at least one employer; assess the at least one candidate; or provide at least one of mentorship, coaching, or training to the at least one candidate.

5. The system of claim 4, wherein the computer processor is further configured to enable the partner to review potential matches between the at least one candidate and at least one employer to determine if the computer processor's analysis requires supplementation and to supplement or override the analysis to force or cancel a match between the at least one candidate and at least one employer.

6. The system of claim 5, wherein the at least one candidate and at least one employer connect to the system through a computerized interface wherein at least some elements of the interface are visible to both parties.

7. The system of claim 5, wherein the computer processor is configured to further consider one or more criteria set by the at least one employer and determine whether the one or more criteria is applicable to the at least one candidate prior to matching.

8. The system of claim 7, wherein the computer processor is configured to enable the at least one employer to adjust the one or more criteria and needs at any time, and is further configured to enable the at least one employer to adjust a matchmaking weight of the one or more criteria and its needs and have the matchmaking weight impact the computer process's determination of whether to match the at least one employer with the at least one candidate.

9. The system of claim 8, wherein the computer processor is configured to permit the at least one employer to adjust the matchmaking weight of the one or more criteria and its needs relative to each other and make the weights of some of the one or more criteria and its needs dependent on the at least one candidate's possession of others.

10. The system of claim 9, wherein the computerized interface is connected to a network and the at least one candidate, if selected by the at least one employer and if the at least one candidate accepted the selection, is capable of performing at least one task related to the needs of the employer using the computerized interface.

11. The system of claim 10, wherein the at least one employer is able to review and receive a result of the at least one candidate's performance of the at least one tasks.

12. The system of claim 11, wherein there are at least two candidates and each has been selected by one of the at least one employers and accepted the selection, and the system is configured to permit each of the two candidates to work on the at least one tasks simultaneously through the computer interface.

13. The system of claim 11, wherein the computer processor is further configured to automatically assign the at least one task to the at least one candidate after the at least one candidate is selected and approves of the selection where the assignment is based on the skillset of that at least one candidate.

14. The system of claim 13, wherein the computer processor is further configured to make the assignment to the at least one candidate based on the skillset of the at least one candidate in relation to the need of the at least one employer.

15. A method for the management of employer and candidate relationships, the method comprising:
maintaining a platform accessible by at least one candidate and at least one employer;
receiving information related to an at least one need of the at least one employer and information related to an at least one skillset of the at least one candidate;
determining whether the at least one skillset of the at least one candidate matches the at least one need of the at least one employer to a sufficient degree wherein the sufficient degree is determined by the at least one employer;
notifying the at least one employer if the at least one skillset of the at least one candidate matches the at least one need of the at least one employer to the sufficient degree set by the at least one employer;
permitting the at least one employer to select the at least one candidate and the at least one candidate to accept the selection by the at least one employer;
providing a computerized workspace where the at least one candidate can perform one or more tasks for the at least one employer where the computerized workspace is at least partially shared between the at least one candidate and at least one employer.

16. The method of claim 15, the method further comprising:
providing a mechanism for the at least one employer to evaluate the at least one candidate's performance on the one or more tasks.

17. The method of claim 16, the method further comprising:
connecting, over a network, the at least one candidate and an at least one partner who provides assistance to the at least one candidate where such assistance is chosen from the list of:
mentorship, training, or coaching.

18. The method of claim 15, the method further comprising:
weighing one or more characteristics of the at least one candidate in addition to the at least one skillset of the at least one candidate based on weights provided by the at least one employer.

19. The method of claim 18, the method further comprising:
facilitating determining the weight of the one or more characteristics and the at least one skillset of the at least one candidate based on the needs of the at least one employer.

20. The method of claim 19, the method further comprising:
automatically assigning at least one task related to the at least one need of the at least one employer to the at least one candidate.
